(19) United States
(12) Patent Application Publication
(10) Pub. No.: US 2006/0167825 A1
(43) Pub. Date: Jul. 27, 2006

(54) System and method for discovering correlations among data

(76) Inventor: Mehmet Sayal, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/041,539

(22) Filed: Jan. 24, 2005

(51) Int. Cl. G06N 5/00

(52) U.S. Cl. 706/45

(57) ABSTRACT

Embodiments of the present invention relate to a system and method for discovering correlations among data. Embodiments of the present invention comprise detecting change points in time-series data streams, defining change point properties based on the change points, grouping together two time-series data streams that have a similar change point property, calculating a behavior index for the two time-series data streams, and assigning the two time-series data streams to a server taking into account the behavior index.

### BACKGROUND OF THE RELATED ART

This section is intended to introduce the reader to various aspects of art which are related to various aspects of the present invention which are described and claimed below. This discussion is believed to be helpful in providing the reader with background information to facilitate a better understanding of the various aspects of the present invention. Accordingly, it should be understood that these statements are to be read in this light, and not as admissions of prior art.

Data correlation includes the identification of causal, complementary, parallel, and reciprocal relationships between two or more comparable data. In dealing with large amounts of data, data correlation is often beneficial because it facilitates discovery of useful relationships that are not otherwise apparent. Once discovered, these relationships are used to improve related operations (e.g., manufacturing processes and delivery systems). For example, in one embodiment of the present invention, a correlation is discovered between a particular process input (e.g., temperature) and the quality of a particular process output (e.g., the hardness of steel). Once such a correlation is known, the process output quality is manipulated by changing the related process input.

Data correlation is important in various different businesses and computing fields (e.g., data analysis, data mining, forecasting, and so forth). Indeed, data correlation provides information that can be used for preemptive issue identification and performance optimization. For example, in one embodiment of the present invention, data correlation is applied to business activity log data to discover correlations among business objects (e.g., how one business object affects other business objects) that can be used to better understand performance issues and thus improve business performance.

One method for discovering correlations among data streams generally relates to enumeration data, where data field entries can take one of a limited number of values that are easily categorized for analysis (e.g., data capable of being arranged in a list). For example, in one embodiment, a data field used for storing customer names contains a few hundred unique data values, which can easily be categorized as enumeration data. A correlation analysis on such discrete data can yield results like: “When customer name is customer1 then product name is Printer with 60% probability.” Such a correlation, for example, indicates to a technical support business that when “customer 1” calls, the likelihood that customer1 is calling for printer support is sixty percent. This allows the technical support business to improve operational efficiency by immediately directing calls from customer1 to particular employees with technical knowledge of printers.

Another type of data is numeric data, which is data that is expressed in numerical terms. Automatically discovering data correlations among numeric data is relatively difficult compared to automatically discovering data correlations among discrete data. This is true because the search space (i.e., the number of data points that need to be compared) is typically much smaller for discrete data.

Still another type of data is time-series data. Time-series data comprises values for numeric data objects coupled with time-stamps as snapshots of time. Analysis of time-series data includes finding or discerning correlations among numeric values over the course of time. Finding time-correlations is often even more difficult than finding correlations among numeric data sequences. This is true because time-distance values are taken into consideration when finding time-correlations. For example, it is often necessary to take into consideration a time delay between a cause and effect, thus increasing the complexity and difficulty of establishing correlations.

### BRIEF DESCRIPTION OF THE DRAWINGS

FIG. 1 is a block diagram illustrating a method for correlating data that illustrates one embodiment of the present invention;

FIG. 2 is a diagram illustrating data aggregation that illustrates one embodiment of the present invention; and

FIG. 3 is a graph providing a graphical example of the selection of candidate distances that illustrates one embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which vary from one implementation to another. Moreover, it should be appreciated that such a development effort could be complex and time consuming, but would nevertheless be a routine undertaking of design, fabrication, and manufacture for those of ordinary skill having the benefit of this disclosure.

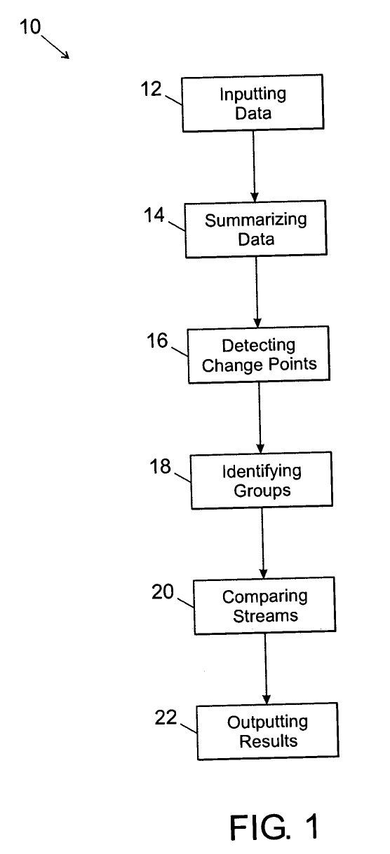

FIG. 1 is a block diagram illustrating a method for correlating data that illustrates one embodiment of the present invention. Specifically, FIG. 1 illustrates a method for identifying time-correlations, which are important in business impact analysis, forecasting, prediction, simulation, and so forth. The method is generally referred to by reference number 10. While FIG. 1 separately delineates specific method operations, in other embodiments, individual operations are split into multiple operations or combined into a single operation. Further, in some embodiments of the present invention, the operations in the illustrated method 10 do not necessarily operate in the illustrated order.

Embodiments of the present invention, such as that shown in FIG. 1, relate to identifying time correlations (i.e., correlations between numeric values over the course of time), which indicate time-based relationships among data objects or time series data streams (TSDSs). For example, embodiments of the present invention identify a time-based relationship such as “when A increases more than 5%, B is expected to increase more than 10% within 2 days with 75% confidence”. As illustrated, method 10 comprises six method operations that are performed in accordance with embodiments of the present invention to facilitate the correlation of TSDSs. Specifically, method 10 includes inputting data (block 12), summarizing data (block 14), detecting change points (block 16), identifying groups (block 18), comparing streams (block 20), and generating and outputting information (block 22).

In accordance with embodiments of the present invention, the initial input (block 12) comprises a plurality of data streams. The output of the process 10 (block 22) includes time-correlation rules. Specifically, in embodiments of the present invention, input data for the method 10 includes any number of data streams, including data streams that are time-stamped (i.e., time-series data). For example, in one embodiment of the present invention, the input data includes product quantity data that is time stamped (e.g., plant A produced 500 gallons of liquid product on Nov. 30, 2000). These data streams include data received from any number of sources, such as data read from one or more database tables, an XML document, or a flat text file with character delimited data fields. I on embodiment of the present invention, output information from method 10 includes a set of time-correlation rules that describe the correlation of data object fields. For example, in one embodiment, output from method 10 comprises time-correlations in the following form:
When A increases more than 5%→B will increase more than 10%
within 2 days (confidence=0.75)
Similarly, in one embodiment of the present invention, output from method 10 comprises time-correlations in the following form:
When A increases more than 5%, followed by an increase of more than 10%
in B→C will increase more than 10% within 1 hour (confidence=0.71).

In accordance with embodiments of the present invention, each time correlation rule (block 22) comprises the following types of information: direction, sensitivity, time delay, and confidence. Direction information includes data relating to a change in value between time-series data. For example, a direction is given a value of “same” if the change in value between one set of time-series data is correlated to a change in the same direction for another set of time-series data (e.g., if both sets of data indicate an increase in value, the direction is “same”). Alternatively, a direction is deemed “opposite” if the change direction is opposite in the two correlated time-series. Sensitivity information relates to a magnitude of change in data values and how responsive one time-series is to changes in another time-series (e.g., an increase in input of 20% results in a 20% increase in output). Time delay information relates to how much time it takes to see a change in the value of one time-series affect the value of another time series (e.g., an increase in input increases output after one hour). Confidence information relates to an indication of the certainty of particular detected time-correlation. For example, confidence information comprises a value from zero to one, where one is the highest certainty and zero is the lowest.

The operations represented by blocks 14 and 16 utilize parallel and distributed algorithms that allow data correlation operations to be dispersed and performed on different servers. Indeed, operations in accordance with embodiments of the present invention are performed on each of a plurality of TSDSs separately and on any number of servers. This ability allows for increased speed in determining correlations. Additionally, embodiments of the present invention reduce unused overhead (e.g., CPU time) and inefficient operation by reducing or eliminating communication overhead among servers. For example, in one embodiment of the present invention, operational burden is evenly distributed among a plurality of servers and comparisons are made on individual servers without requiring any exchange of information between servers. It should be noted that the term “server” is used herein to refer to a computer or CPU that participates in an application of the method 10. For example, in one embodiment, the term “server” refers to a CPU (central processing unit) in a parallel computing environment that participates in an application of the method 10.

Embodiments of the present invention are performed with several different computing environments including the following types of computing environments: centralized, parallel, and distributed. A centralized computing environment includes a single server. For example, a centralized computing environment includes a single desktop computer. A parallel computing environment in accordance with embodiments of the present invention includes a computer with a plurality of CPUs wherein each CPU is adapted to apply data summarization and change point detection independently from other CPU's. For example, a parallel computing environment includes a multiprocessor computer. A distributed computing environment in accordance with embodiments of the present invention comprises a plurality of servers, wherein each server is adapted to receive any random set of TSDSs and apply the two operations represented by blocks 12 and 14 on the received data (block 12). For example, a distributed computing environment includes a plurality of computers connected through a LAN.

Blocks 14-18 are performed in accordance with embodiments of the present invention to group data and prevent inefficient information exchange across servers. Block 14 represents summarizing data, which includes data aggregation in accordance with embodiments of the present invention. Data aggregation includes summarization of numeric data for different time units. A total value of data for each time unit comprises a data summary in accordance with embodiments of the present invention. For example, in one embodiment of the present invention, if a process produces an alarm at 1:01 PM, 1:08 PM, and 1:35 PM, a data summary indicates that the hour from 1:00 PM-2:00 PM included 3 alarms. In some embodiments of the present invention, an average of numeric values is taken at each time hierarchy level.

It is desirable to summarize time-series data, in accordance with embodiments of the present invention, for two main reasons. First, summarization is desirable to reduce the search space (i.e., reduce the amount of data to be analyzed) and thus simplify and improve efficiency. Time-series data typically comprises a large volume of data. Such large volumes are typically difficult to manage, requiring excessive amounts of time and resources to analyze. Accordingly, it is often more efficient to summarize the data before performing any type of analysis on it. Further, some embodiments of the present invention apply automatic data aggregation and change detection algorithms in order to reduce necessary search space. Second, summarization is desirable to facilitate comparison of data streams that are not readily comparable. Timestamps associated with the time-series data often do not match each other, thus hindering analysis. For example, in one embodiment of the present invention, some timestamp data is recorded with units of minutes, while other timestamp data is recorded with units of hours. Such mismatched time granularities (e.g., seconds, minutes, hours, days, weeks, months, years) prevent accurate comparison. Accordingly, it is desirable to summarize data using higher time granularity than the granularities used for the original timestamps. This facilitates comparison of the recorded data with each other.

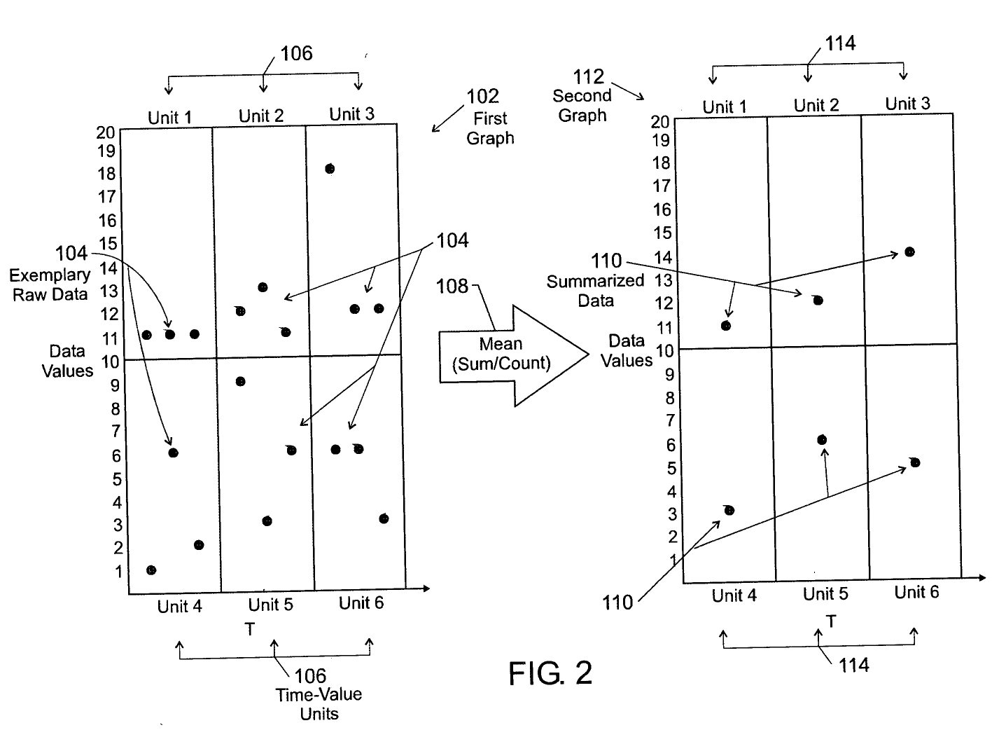

FIG. 2 is a diagram illustrating data aggregation that illustrates one embodiment of the present invention. As discussed above, the summarization of data in block 14 includes such data aggregation. Specifically, FIG. 2 illustrates an example of how data aggregation can be done at any particular time granularity level (e.g., minutes, hours, days, and so forth) using two graphs. In a first graph 102, exemplary raw data 104 are plotted according to associated data values (Data Values on the Y-axis) and time-stamps (T on the X-axis). The first graph 102 is divided into time-value units 106 that are each individually labeled (e.g., Unit 1, Unit 2 and so forth). The aggregation is performed by calculating the sum, count, mean, min, max, and standard deviation of individual data values within each time-value unit 106.

In one embodiment of the present invention, the raw data 104 illustrated in the first graph 102 is summarized by adding all of the data values represented in each time-value unit 106, and dividing the acquired total by the count of raw data 104 within that same time-value unit 106. For example, in Unit 1 of the first graph 102, the sum of data values would be 33 (i.e., 11+11+11) and this sum would be divided by the number of data points in the same unit (i.e. 3). This summarization procedure is represented by arrow 108 and its results are referred to as summarized data 110, which is illustrated in a second graph 112.

In the second graph 112, the summarized data 110 are plotted against the same axis values used in the first graph 102 (i.e., Data Values and T). Like the first graph 102, the second graph 112 is divided into time-value units 114. The time-value units of the second graph 112 correspond to the time-value units of the first graph 102 and are labeled accordingly. For example, the raw data in Unit 1 of the first graph 102 is summarized in Unit 1 of the second graph 112. Accordingly, Unit 1 in the second graph contains a summarized data point 110 with a data value of 11 (i.e., 33 divided by 3) as calculated previously.

It is often desirable to consider cases in which the effect of a change in one TSDS cannot always be observed exactly within the same time delay. For example, effects of changes generally occur slightly shifted in the time domain because of lapses in time between cause and effect (e.g., a change in the input of a process does not always immediately change the output). Further, the time delay is not always consistent. In order to capture such cases, embodiments of the present invention use moving windows of three time units at any granularity level. A moving window calculation includes calculating a function over a certain continuously updated range of data. For example, aggregation of data values in the “hour” granularity involves the current hour as well as the previous and next hours. In some embodiments of the present invention, a plurality of windows is used to capture different time delays. Further, it should be noted that increasing window size does not necessarily increase accuracy. For example, utilizing ten windows does not provide results that are significantly more accurate than results from utilizing five windows.

Detecting change points (block 16) in accordance with embodiments of the present invention includes the use of a statistical method that detects significant trend changes in numeric data streams. For example, a cumulative sum (CUSUM) is used in accordance with embodiments of the present invention to detect significant change points in TSDSs. CUSUM is a computation of a statistical method for detecting change points in time-stamped numeric data or time-series data. It should be noted that the CUSUM is not the cumulative sum of the data values but the cumulative sum of differences between the values and the average. For example, CUSUM at each data point is calculated as follows. First, the mean (or median) of the data may be subtracted from the value of each data point. Next, for each point, all the mean and median-subtracted points before the data point are added. Then, the resulting values are defined as the Cumulative Sum (CUSUM) for each point.

The CUSUM analysis is often useful for picking out general trends from random noise because noise tends to cancel out as an increasing number of values are evaluated. For example, there are generally just as many positive values of true noise as there are negative values of true noise and these values will generally cancel one another. A trend is often visible as a gradual departure from zero in the CUSUM. Therefore, in one embodiment of the present invention, CUSUM is used for detecting sharp changes and also gradual but consistent changes in numeric data values over the course of time. Indeed, CUSUM is especially useful in accordance with embodiments of the present invention because it can efficiently detect both gradual and sudden changes in data values, and it can be calculated incrementally.

CUSUM is calculated incrementally for each TSDS as data flow is received in accordance with embodiments of the present invention. For each new data value, a new mean is calculated that takes into consideration all of the data points up to the current data point. For example, a mean value is calculated incrementally by dividing a sum of values up to (but not including) the current data point by a count of values up to (but not including) the current data point. A new CUSUM at a current data point is then calculated by adding the difference between the new data point and the mean to the previous CUSUM as illustrated by the following equation:
CUSUM(i)=CUSUM(i−1)+[data(i)−mean(i)]
It should be noted that excluding the current data point from the mean value calculation prevents the current value from reducing the difference between the mean and current value. For example, if the current value is extremely large it will have a disproportionate effect on the mean.

Mean and CUSUM values often change dramatically as new data is accumulated in accordance with embodiments of the present invention. Accordingly, a refreshing mechanism is applied in accordance with embodiments of the present invention to diminish the effect of older data on mean and CUSUM calculations as new data is received. Several different types of refreshing mechanisms are utilized in accordance with embodiments of the present invention to refresh mean and CUSUM values.

In accordance with embodiments of the present invention, a fixed-size moving window over the data values is used as a refreshing mechanism. For example, in one embodiment of the present invention, mean and CUSUM calculations are preformed on data values within the moving window. If the moving window size is K, the mean and CUSUM at each data point is calculated using the latest K data points. The fixed-size moving window mechanism has limited utility because its accuracy is very sensitive to the selected window size. Accordingly, the window size often requires adjustment for different TSDSs to enable successful application.

In accordance with embodiments of the present invention, an aging mechanism is used to refresh mean and CUSUM values. Aging mechanisms use weights to merge the new and old calculated values such that the effect of older data values on the calculated values diminish as new data values arrive. The aging mechanism is applied by using the following formula in accordance with embodiments of the present invention:
Y(i)=Y(i−1)*(1−r)+data(i)*r,
where Y(i) represents the new calculated value, Y(i−1) represents the previous calculated value, data(i) represents the current data value, and r represents the parameter. Aging mechanisms can generally be applied to any TSDS successfully. This is true because the selected value of r does not cause a significant accuracy issue. However, a value between 0.2 and 0.5 is recommended for the r value.

In one embodiment of the present invention, once a CUSUM value for every data point is calculated, the calculated CUSUM values are compared with upper and lower thresholds to determine which data points should be marked as change points. The data points for which the CUSUM value is above the upper threshold or below the lower threshold should be marked as change points. In one embodiment of the present invention, the upper and lower thresholds are determined using standard deviation (i.e. a fraction or factor of standard deviation). A moving mean or standard deviation is generally readily calculable using a moving window. For example, in one embodiment of the present invention, the last n data values are kept in memory and used to perform calculations. When new data values are available, they replace the oldest of the n data. Therefore, it is assumed that standard deviation can be readily calculated on any time-series data. Embodiments of the present invention use one standard deviation (σ) distance from mean (μ) to set the thresholds (μ±σ) in order to detect both medium and large scale change points, while ignoring small fluctuations. In other embodiments of the present invention, the upper and lower thresholds are determined by a similar calculation or are set to two constant values.

Once change points are established, the change points are labeled in accordance with embodiments of the present invention. In one embodiment of the present invention, the detected change points are marked with labels indicating the direction of the detected change. For example, in one embodiment of the present invention, a point is marked “Down” where a trend of data values changes from up to down, a point is marked “Up” where a trend of data values changes from down to up, and a point is marked “Straight” when the trend does not change. Further, an amount of change is recorded for each change point. This amount of change is used for sensitivity analysis in method 10 while comparing TSDSs in accordance with embodiments of the present invention. Further, sensitivity analysis is embedded inside change detection and correlation rule generation operations (blocks 16 and 22) in accordance with embodiments of the present invention.

After detecting change points in block 16, embodiments of the present invention identify TSDSs with similar behaviors and establish certain data groupings. Block 18 represents identifying TSDSs that have similar behavior in accordance with embodiments of the present invention. This operation requires certain information regarding change points. Some information includes a number of change points, a change type, and a magnitude of change. This information is used to group the TSDSs so that certain groups can be directed to a single server, thus preventing the need to exchange information between a plurality of servers. For example, in one embodiment of the present invention, two TSDSs each have one-hundred change points, establishing a similarity and thus a reason for grouping them. In addition to considering the similarity in the number of change points, two TSDSs have a similar count of change point directions, thus establishing a further reason for grouping the two TSDSs. For example, in one embodiment of the present invention, two TSDSs each have one-hundred change points consisting of approximately ninety upward changes and ten downward changes. However, if one of the two TSDSs had a different number of changes (e.g., approximately fifty upward changes and fifty downward changes), that would justify not grouping the two TSDSs.

In accordance with embodiments of the present invention, more accurate groupings are provided by considering more information relating to the TSDSs. In other words, increasingly higher percentages of TSDSs that will actually provide correlations are included in groups by considering more information to select the groups. Accordingly, several levels of accuracy are accessible dependent upon how much information is utilized. For example, if the count or number of change points is considered, that constitutes a first level of accuracy. A second, higher level of accuracy is achieved by additionally considering either the direction of changes or the magnitude. Further, a third and even higher level of accuracy is achieved considering at all three types of information (i.e., count, direction, and magnitude). Higher levels of accuracy are achieved by considering other information relating to the TSDSs prior to grouping them. The accuracy improves performance in accordance with embodiments of the present invention by limiting the amount of data that is compared on a server. In other words, by initially sorting the TSDSs into groups, exchanges between servers and redundant calculations on multiple servers are often avoided, thus preventing the waste of valuable CPU time and network bandwidth.

In some embodiments of the present invention, ascertainment of this information for grouping is incorporated in the detection of change points (block 16) without adding significant running time cost. Additionally, in accordance with embodiments of the present invention, the number of detected change points and their behavior index is also calculated as part of the detection operation (block 16). A behavior index includes a single number that identifies the recent behavior of a change point data stream. For example, the number four represents both a number of change points and related directions. Specifically, the value of four is the difference between the total number of change points and the number of downward change points (i.e., 7 change points−3 downward change points=an index value of 4). In accordance with embodiments of the present invention, behavior indexes take into consideration time distances between the most recent change points in a data stream and directions of those change points. In other words, a behavior index is a function of the time distances and directions of the most recent change points in a data stream.

Both behavior indexes and change point counts are calculated in accordance with embodiments of the present invention using a moving window calculation of behavior index and counts. For example, in one embodiment, behavior index is calculated by summing the multiplications of time distance and directions of the change points in a sliding window of a fixed time length as follows:
BI=Σ distance(i, i−1)*direction(i), ∀i such that (t−T) ≦timestamp(i) ≦t
In this exemplary equation, BI represents the behavior index, distance(i, i−1) represents the time distance between i'th and (i−1)'th change points, direction(i) represents the numeric representation of the direction of the i'th change point (e.g., 1 for up; −1 for down), timestamp(i) represents the timestamp of change point i, t represents the current time, and T represents the length of the sliding window.

Identifying TSDSs with similar behaviors in block 18 includes assigning the change point data streams to available servers such that the data streams having similar behaviors are grouped together for comparison in block 20. Assignments in accordance with embodiments of the present invention is based on a hash function (hash) that takes behavior indexes of data streams and returns identification numbers (k) for servers. A hash includes a mathematical formula that converts a message of any length into a unique fixed-length string of digits. A hash function comprises an integer division step and a modulo operation. For example, a behavior index having a value of 121 is divided by a number of servers 10 (121 divided by 10=12). The integer division result 12 is then used in a modulo operation wherein the integer value 12 is divided by the number of servers using integer division again (12 divided by 10=1 and remainder is 2) and the remainder is taken as the result. Thus, the modulo operation results in a value of 2, which is the hash value.

In a distributed computing environment, the participating servers periodically exchange the behavior index values of all TSDSs that the servers have been receiving. Accordingly, the hash function is chosen such that it returns the same server number for behavior indexes (BI) that are similar to each other:
Hash(BI)→k, such that 0≦k≦(P−1), where P is the number of servers available.
Moreover, the hash function assigns the data streams as evenly as possible among available servers. An example for such a hash function is an integer division followed by a modulo (mod) operation such that S data streams are divided into P groups using modulo base equal to P.

Embodiments of the present invention take advantage of all available resources (e.g., servers or CPU's) in block 18 by proceeding in a manner dependent upon what type of computing environment is being utilized. In other words, embodiments of the present invention proceed differently for different computing environments to improve operational efficiency. In a centralized environment, block 18 represents recording all change points in a single TSDS and the method 10 continues to execute on a single server without any alterations. Likewise, in a parallel environment, the change points are recorded into a single TSDS and the method 10 continues to execute. However, in a parallel environment, access to the single TSDS of change points is synchronized using constructs for synchronization and mutual exclusion (e.g., locks or semaphores) so that one CPU can access the combined TSDS simultaneously. Alternatively, in a distributed environment, change point records are distributed among available servers. This distribution is such that the TSDSs having similar behavior (e.g., a similar number of change points with the same or opposite directions) are grouped together and end up at the same server.

Actual comparison of the TSDSs having similar behavior is then performed as illustrated by block 20. Comparing change points in block 20 includes determining the time distance (d) for which the confidence of time-correlation is the highest for a group of two or more data streams. For example, in a pair-wise comparison of two TSDSs A and B, a time distance (d) is determined for which the highest number of matching points (e.g., change points in the same or opposite direction) exists. The magnitude of time-correlation is measured as the maximum confidence value for the group of data streams among all possible time distances, which equals to the percentage of times the data streams have matching change points with a distance (d).

It should be noted that an exhaustive search of time distances is often prohibitive because of performance reasons. Accordingly, embodiments of the present invention use sampling in order to select candidate time distances that are likely to return a high time-correlation for a group of data streams. A high time-correlation is defined to be a correlation above a predefined threshold (e.g., 30% or more change points having comparable distances). For example, in one embodiment of the present invention, a change point is arbitrarily chosen from a particular time series and a determination is made as to whether it matches a change point in another time series based on behavior indexes. If the match occurs within a particular time (e.g., 5 minutes), that time is considered as a possible candidate. Sampling helps avoid checking for every possible time distance. Indeed, relatively few candidate distances are used to determine if a high correlation exists. Although the number of candidate distances considered have a significant effect on accuracy of results, it has been shown that it is enough to consider a total of four or five candidate distances to find the highest time-correlation distance accurately 95% of the time.

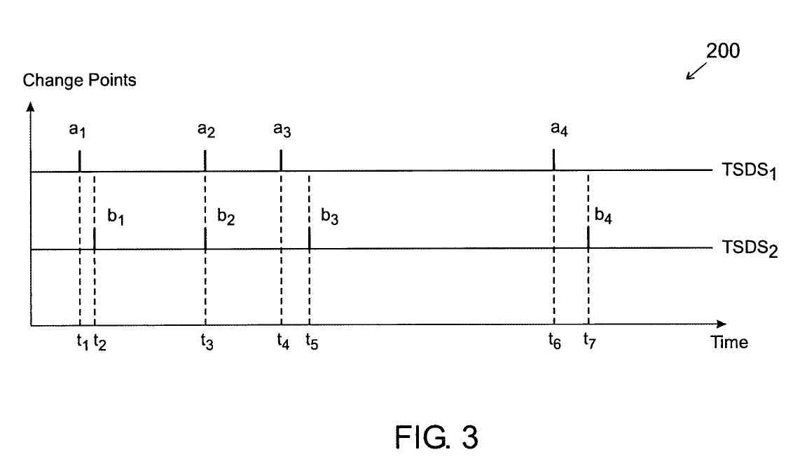

FIG. 3 is a graph providing a graphical example of the selection of candidate distances that illustrates one embodiment of the present invention. The graph in FIG. 3 is generally referred to by reference numeral 200. Specifically, graph 200 shows change points detected for a pair of TSDSs (TSDS1 and TSDS2). As previously discussed, if two or more TSDSs are time-correlated, most of their change points should have matching or corresponding points in one another. Therefore, an analysis of which change points correspond and what the time distances are between them yields a list of candidate distances.

It should be noted that in most cases, matching change points are within very close time distances. For example, if change point a1 has a matching point in TSDS2, it is most likely one of the change points b1, b2, or b3. Accordingly, embodiments of the present invention consider the distance of a1 with any of b1, b2, or b3 as candidate distances. Namely, in one embodiment of the present invention, |t2−t1| is one candidate distance. Similarly, |t3−t1| and |t5−t1| are other candidate distances. By randomly picking a few change points from a first TSDS (e.g, TSDS1) and finding candidate distances for possible matching points in a second TSDS (e.g., TSDS2), a set of candidate distances for the pair of TSDSs can be discerned in constant running time. In one embodiment of the present invention, the candidate distance selection and comparison is performed in both directions between pairs of TSDSs (i.e., from TSDS1 to TSDS2 and from TSDS2 to TSDS1).

Once the distance (d) for the maximum confidence (mc) of time-correlation between two TSDSs is calculated, the maximum confidence is compared with a predefined threshold (e.g., 0.5). If maximum confidence is higher than the threshold, a time-correlation rule is generated that has time distance d and confidence mc for the pair of TSDSs in consideration. In accordance with embodiments of the present invention, the comparisons is performed for all possible combinations of TSDSs for which the behavior indexes are close to each other.

While the invention is susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method for discovering correlations among data, comprising:
detecting change points in time-series data streams;
defining change point properties based on the change points;
grouping together two time-series data streams that have a similar change point property;
calculating a behavior index for the two time-series data streams; and
assigning the two time-series data streams to a server taking into account the behavior index.

2. The method of claim 1, further comprising:
determining a time distance for which a confidence of time-correlation is high for the two time-series data streams; and
generating a time-correlation rule from the time distance.

3. The method of claim 1, further comprising summarizing the two time-series data streams.

4. The method of claim 1, further comprising using parallel and distributed algorithms to provide distribution of the two time-series data streams among a plurality of servers.

5. The method of claim 1, further comprising detecting trend changes in the time-series data streams using a CUSUM function.

6. The method of claim 1, further comprising refreshing the time-series data streams using an aging mechanism.

7. The method of claim 1, further comprising defining a direction for a one of the change points as a change point property.

8. The method of claim 1, further comprising defining a count of change points in a one of the time-series data streams as a change point property.

9. The method of claim 1, further comprising defining a magnitude of change as a change point property.

10. The method of claim 1, further comprising:
recording all change points into a single time-series data stream; and
synchronizing access to the single time-series data stream using constructs for synchronization and mutual exclusion such that only a single server can access the single time-series data stream at a time.

11. The method of claim 1, further comprising:
recording the change points to create change point records; and
distributing the change point records among available servers such that similar time-series data streams are at the same server.

12. A method for discovering correlations among data, comprising:
detecting change points in time-series data streams;
defining a set of change point properties;
forming a time-series data group from the time-series data streams, wherein the time-series data group includes time-series data streams having similar change point properties; and
assigning the time-series data group to a server using an algorithm based on a type of computing environment in which the server resides.

13. The method of claim 12, further comprising calculating a behavior index and using the behavior index with the algorithm to assign the time-series data group.

14. The method of claim 12, wherein the algorithm is a parallel algorithm.

15. The method of claim 12, further comprising determining a time distance value for which a time-correlation meets a threshold value for the time-series data group.

16. The method of claim 15, further comprising generating a time-correlation rule from the time distance.

17. The method of claim 12, further comprising refreshing the time-series data streams using an aging mechanism.

18. A system for discovering correlations among data, comprising:
a change point detection module adapted to detect change points in time-series data streams;
a property module adapted to define a set of change point properties;
a grouping module adapted to form a time-series data group from the time-series data streams, wherein the time-series data group includes time-series data streams having similar change point properties;
a behavior index module adapted to calculate a behavior index for the time-series data group; and
an assigning module adapted to assign the time-series data group to a server using the behavior index.

19. The system of claim 18, further comprising:
a time distance module adapted to determine a time distance for which a confidence of time-correlation is high for the time-series data group; and
a rule module adapted to generate a time-correlation rule based on the time distance.

20. The system of claim 18, further comprising a time granularity module adapted to summarize the time-series data streams at different time granularities.

21. Application instructions on a computer-usable medium where the instructions, when executed, effect discovering correlations among data, comprising:
a change point detection module adapted to detect change points in time-series data streams;
a property module adapted to define a set of change point properties;
a grouping module adapted to form a time-series data group from the time-series data streams, wherein the time-series data group includes time-series data streams having similar change point properties;
a behavior index module adapted to calculate a behavior index for the time-series data group; and
an assigning module adapted to assign the time-series data group to a server using the behavior index.

22. The application instructions of claim 21, further comprising a summarization module adapted to summarize the time-series data streams.

23. The application instructions of claim 21, further comprising a time distance module adapted to determine a time distance for which a confidence of time-correlation is high for the time-series data group.

24. The application instructions of claim 23, further comprising a rule module adapted to generate a time-correlation rule based on the time distance.

25. The application instructions of claim 21, further comprising a time granularity module adapted to summarize the time-series data streams at different time granularities.

26. A system for discovering correlations among data, comprising:
means for detecting change points in time-series data streams;
means for defining change point properties using the change points;
means for grouping together two of the time-series data streams having a similar change point property;
means for calculating a behavior index for the two time-series data streams; and
means for assigning the two time-series data streams to a server using the behavior index.

27. A method for discovering correlations among data, comprising:
detecting change points in time-series data streams;
defining a set of change point properties;
forming a time-series data group from the time-series data streams, wherein the time-series data group includes time-series data streams having similar change point properties;
assigning the time-series data group to a server using an algorithm using a type of computing environment in which the server resides;
calculating a behavior index and using the behavior index with the algorithm to assign the time-series data group;
determining a time distance value for which a time-correlation meets a threshold value for the time-series data group;
generating a time-correlation rule using the time distance; and
refreshing the time-series data streams using an aging mechanism.
